(19) United States
(12) Patent Application Publication
(10) Pub. No.: US 2013/0153617 A1
(43) Pub. Date: Jun. 20, 2013

(54) TEMPORARY SIDE CARGO RACK

(71) Applicants: Bryon J. Bierman, Primos, PA (US); Shawn Chappman, Primos, PA (US)

(72) Inventors: Bryon J. Bierman, Primos, PA (US); Shawn Chappman, Primos, PA (US)

(73) Assignee: BIERDICI, LLC, Primos, PA (US)

(21) Appl. No.: 13/328,502

(22) Filed: Dec. 16, 2011

(51) Int. Cl. B60R 11/00

(52) U.S. Cl. 224/572

(57) ABSTRACT

A temporary side cargo rack for a vehicle is provided having a first rack member and a second rack member. Each of the first and second rack members includes a support leg having a first axial end and a second axial end. A connection element is associated with the first axial end of each support leg and configured to be removably connected to an existing component of a vehicle. A support element is associated with the second axial end of each support leg. The support element includes a base arranged substantially perpendicular to the support leg and a flange that extends from the base. An attachment component is provided that includes a first end removably associated with at least one of the support element or the second axial end of the support leg, and a second end configured to be removably associated with the vehicle.

### FIELD OF INVENTION

This application is generally related to cargo racks, and more particularly related to a temporary side cargo rack that can be removed from a vehicle or conveyance when not in use.

### BACKGROUND

Many vehicles or conveyances have cargo racks for carrying large objects that cannot be easily placed in the trunk or interior of the vehicle or conveyance. Known cargo racks include roof racks that hold objects on top of the vehicle, side racks that hold objects along a side of the vehicle, and rear racks that hold objects behind the vehicle. Side racks are often used in the construction industry to transport large sheets of material such as lumber, paneling, drywall, and glass. Due to the size and weight of these materials, it is often not possible or impractical to place them inside of the vehicle or on a roof rack, even in spacious vehicles such as trucks and vans. Transporting these materials with a vehicle having a side rack speeds up loading and unloading while minimizing the likelihood of damage. However, existing side racks are permanent systems that must be fixed to the vehicle, and can be cumbersome, unsightly, and costly. Those who work in the construction industry may have graphics or advertisements printed on the side of their vehicles that would be obstructed by a side rack. In addition, a permanent side rack is undesirable for those who only require a side rack for certain projects, or non-professionals such as homeowners working on home improvement projects. Therefore, a need exists for a temporary side cargo rack that can be easily and securely attached to a vehicle and removed when not in use.

### SUMMARY

A temporary side cargo rack for a vehicle is disclosed, the temporary side cargo rack includes a first rack member and a second rack member. Each of the first and second rack members includes a support leg having a first axial end and a second axial end. A connection element is associated with the first axial end of each support leg and configured to be removably connected to an existing component of a vehicle. A support element is associated with the second axial end of each support leg, the support element having a base arranged substantially perpendicular to the support leg and a flange that extends from the base. Each of the first and second rack members can further include a spacer adapted to space the second axial end of the support leg from a side surface of a vehicle. Each of the first and second rack members also includes an attachment component having a first end removably associated with at least one of the support element or the second axial end of the support leg, and a second end configured to be removably associated with the vehicle. The attachment component is used to secure the first and second rack members to the vehicle so that movement of the temporary side cargo rack relative to the vehicle is minimized, especially while the vehicle is moving.

A removable side cargo rack for a vehicle having an existing roof rack is also disclosed. The removable side cargo rack include a first rack member and a second rack member, each of the first and second rack members having a first end removably connected to a portion of the existing roof rack, and a second end configured to support an object thereon. The first end of each of the first and second rack members can include a connection element having an opening adapted to receive a protrusion of the existing roof rack therein. This allows the removable side cargo rack to be easily connected to the vehicle without the need for tools, hardware, or modifications to the vehicle, and then be quickly removed from the vehicle when not in use. The second end of each of the first and second rack members can be formed as a substantially U-shaped member, so that an object to be transported can be safely supported by the removable side cargo rack. The second end of each of the first and second rack members can further be associated with a bottom portion of the vehicle by an attachment component.

For sake of brevity, this summary does not list all aspects of the present side cargo rack, which is described in further detail below.

### BRIEF DESCRIPTION OF THE DRAWINGS

The foregoing summary, as well as the following detailed description of the preferred embodiments, will be better understood when read in conjunction with the appended drawings. For the purpose of illustrating the invention, there is shown in the drawings embodiments which are presently preferred. It should be understood, however, that the invention is not limited to the precise arrangements shown in the drawings.

FIG. 1 is a perspective view of an embodiment of the temporary side cargo rack connected to an existing roof rack of a vehicle.

FIG. 2 is an exploded view of a rack member of the temporary side cargo rack shown in FIG. 1.

FIG. 3 is a perspective view of the rack member of the temporary side cargo rack shown in FIG. 1.

FIG. 4 is a perspective view of a connection element of the temporary side cargo rack shown in FIG. 1.

FIG. 5 is a top view of a spacer and a bumper of the temporary side cargo rack shown in FIG. 1.

FIG. 6 is a side elevational view of a support leg of the temporary side cargo rack shown in FIG. 1.

FIG. 7 is a front elevational view of the temporary side cargo rack shown in FIG. 1 connected to an existing roof rack of a vehicle.

FIG. 8 is a front elevational view of the connection element shown in FIG. 4.

FIG. 9 is a top plan view of the connection element shown in FIG. 4.

FIG. 10 is a left side elevational view of the connection element shown in FIG. 4.

FIG. 11 is a top plan view of an alternative embodiment of a connection element of the temporary side cargo rack shown in FIG. 1.

FIG. 12 is a top plan view of another alternative embodiment of a connection element of the temporary side cargo rack shown in FIG. 1.

### DETAILED DESCRIPTION OF THE PREFERRED EMBODIMENTS

Certain terminology is used in the following description for convenience only and is not limiting. The words “front,” “back,” “left,” “right,” “inner,” “outer,” “upper,” “lower,” “top,” and “bottom” designate directions in the drawings to which reference is made. Additionally, the terms “a” and “one” are defined as including one or more of the referenced item unless specifically noted otherwise. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

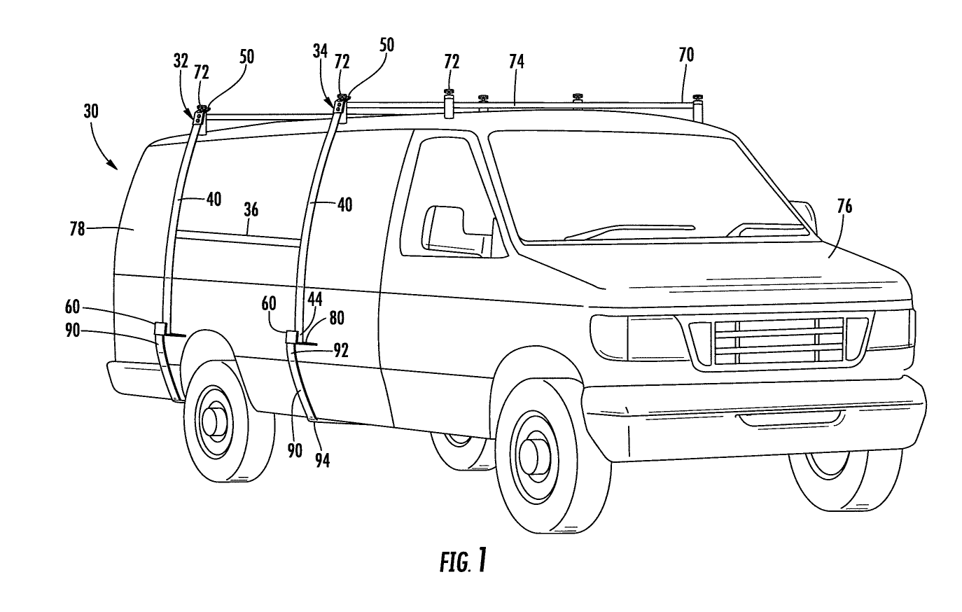

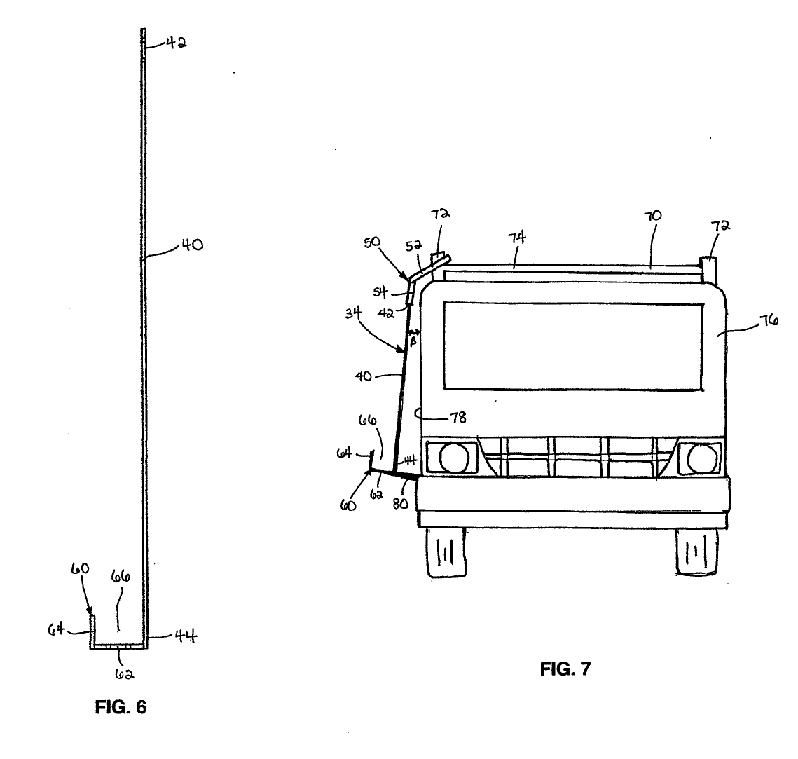

FIGS. 1 and 7 show one embodiment of a temporary side cargo rack 30 according to the present application. The temporary side cargo rack 30 is configured to be removably associated with an existing component of a vehicle without the need for complicated assembly steps, tools, hardware, or any modifications to the vehicle. As discussed below in detail, the existing component of the vehicle can be any suitable component or surface that allows for a removable connection, such as, for example and without limitation, an existing roof rack, ladder rack, surface paneling, or a gutter formed between the side and top surfaces of the vehicle, preferably as well as a rocker panel, bottom panel seam, or frame rail. The temporary side cargo rack 30 is modular, removable, space efficient, cost effective, and can be easily connected and disconnected from the vehicle without any alterations or damage to the vehicle. When not in use, the temporary side cargo rack 30 can be stored and transported in a trunk, bed, or interior space of the vehicle. The temporary side cargo rack 30 includes a first rack member 32 and a second rack member 34, which are arranged to be spaced apart from each other. Although only first and second rack members 32, 34 are shown in FIG. 1, additional rack members can be provided to provide further support for an object to be transported, such as an object having greater weight or a length that extends past the first and second rack members 32, 34. A temporary side cargo rack 30 having only first and second rack members 32, 34 can preferably be used to support loads of up to approximately 250 pounds. The first and second rack members 32, 34 are each removably associated with an existing component of a vehicle, and can be separate from each other. Optionally, a joining element such as a cross member 36 can be used to connect the first and second rack members 32, 34 together to provide further structural support for the temporary side cargo rack 30 and to minimize relative movement between the first and second rack members 32, 34.

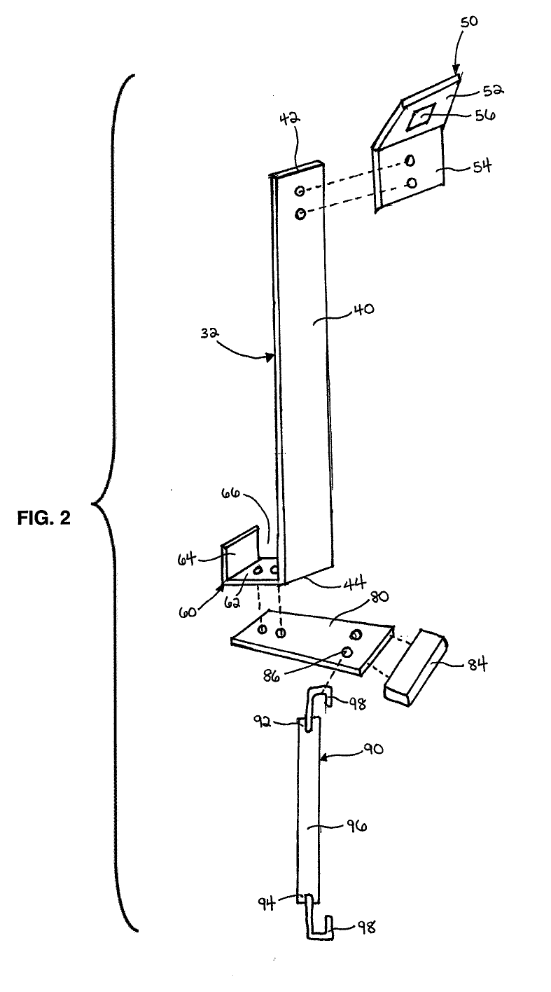

For illustrative purposes, only the components of the first rack member 32 are shown in detail in FIGS. 2 and 3. The second rack member 34 is preferably identical to the first rack member 32 and the components of the second rack member 34 are therefore the same as those of the first rack member 32, and the same reference numerals are used to identify corresponding components. As shown in FIGS. 2, 3, and 6, each of the first and second rack members 32, 34 includes a support leg 40 having a first axial end 42 and a second axial end 44. The length and width of the support leg 40 can be selected based on the material the support leg 40 is made from, the types of vehicles the temporary side cargo rack 30 is designed to be used with, and the weight and dimensions of objects to be carried. For example, when the temporary side cargo rack 30 is used to transport objects such as ladders, lumber, drywall, plywood, MDF boards, and other materials or equipment on the side of a van, the support leg 40 of each of the first and second rack members 32, 34 can be made from steel and have a length of approximately 55 inches and a width of approximately 2 inches.

The first axial end 42 of each support leg 40 is configured to be removably connected to an existing component of a vehicle, and the second axial end 44 of each support leg 40 is configured to support an object thereon. Specifically, a connection element 50 can be associated with the first axial end 42 of each support leg 40, the connection element 50 being configured to be removably connected to the existing component of the vehicle. The connection element 50 and the first axial end 42 of each support leg 40 can be formed together as a single integral component, or as separate pieces that are joined together as shown in FIG. 2. The connection element 50 is preferably removably associated with the first axial end 42 of each support leg 40 using any suitable means such as a sliding connection, a locking connection, a bayonet coupling, or mechanical fasteners including bolts, screws, and clips. As discussed below in detail, such a removable association allows the connection element 50 to be exchanged depending on the type, size, and shape of the existing vehicle component that the temporary side cargo rack 30 is connected to.

A support element 60 is associated with the second axial end 44 of the support leg 40. The support element 60 can include a base 62 arranged substantially perpendicular to the support leg 40 and a flange 64 that extends from the base 62. The flange 64 is preferably arranged substantially parallel to the support leg 40. In this manner, a channel 66 is formed between the support leg 40 and the flange 64, so that a lower portion of an object supported by the support element 60 can be retained within the channel 66 during transport. As shown in FIGS. 2, 3, and 6, the support element 60 can be formed integrally with the second axial end 44 of the support leg 40, such as by forming the second axial end 44 of the support leg 40 to be substantially U-shaped through bending or other appropriate methods. Alternatively, the support element 60 and the second axial end 44 of the support leg 40 can be formed as separate pieces that are joined together by any suitable means, such as, for example and without limitation, welding, mechanical fasteners, adhesives, a sliding connection, or a force fit. The support leg 40, connection element 50, and support element 60 of each of the first and second rack members 32, 34 can be made from any suitable material, and can be each made from the same material or from different materials, including for example and without limitation, one or more of metals such as aluminum, iron, steel, and stainless steel, plastics, composite materials, fabrics, and nylon.

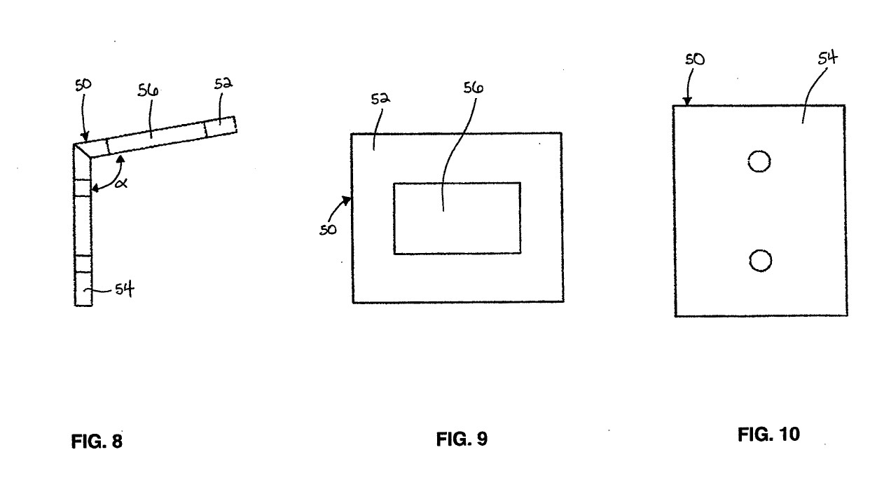

As shown in FIGS. 2, 3, 4, and 8, the connection element 50 can include a top portion 52 and bottom portion 54, the top portion 52 being arranged at an angle α with respect to the bottom portion 54. For example and without limitation, the top portion 52 can be arranged at an approximately 100° angle with respect to the bottom portion 54. The top portion 52 can be adapted to be connected to the existing component of the vehicle and the bottom portion 54 can be adapted to be connected to the first axial end 42 of the support leg 40. The specific configuration of the top portion 52 of the connection element 50 depends on the type of existing vehicle component that the temporary side cargo rack 30 is being connected to. For example, many vehicles include existing roof racks, which provide a variety of components to which the connection element 50 can be removably associated. In the construction industry, many vehicles include a specific type of roof rack known as a ladder rack 70, which can be attached to the top surface of a vehicle 76 as shown in FIGS. 1 and 7, or supported above the bed of a pickup truck by vertical members. The majority of known ladder racks include vertical protrusions 72 that extend above horizontal cross members 74 that form a support surface for a ladder or other object to be carried by the ladder rack 70. Although the term “ladder rack” is used in the following description of FIGS. 1 and 7, the use of the present temporary side cargo rack 30 is not restricted to a ladder rack 70 as described. Instead, the temporary side cargo rack 30 can be used with any roof rack or other existing component of the vehicle that provides a protrusion or other suitable connection member.

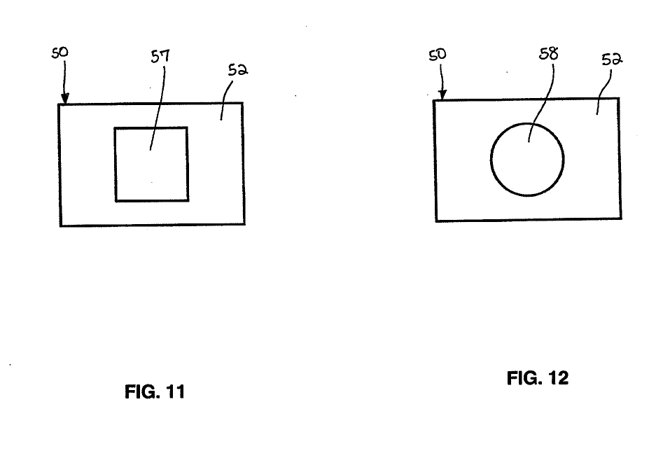

For vehicles equipped with an existing roof rack, such as a ladder rack 70 having spaced apart vertical protrusions 72, the first and second rack members 32, 34 of the present temporary side cargo rack 30 can be easily connected to and disconnected from respective ones of the vertical protrusions 72. As shown in FIGS. 2-4 and 9, the top portion 52 of the connection element 50 can include an opening 56 adapted to receive the vertical protrusion 72 of the ladder rack 70 therein. The shape and size of the opening 56 of the connection element 50 can be selected to match the dimensions of the vertical protrusion 72 of the existing ladder rack 70. For example and without limitation, the opening 56 of the connection element 50 can be substantially rectangular as shown in FIG. 9, and can have dimensions of approximately 2 ⅛ inches by 1 ⅝ inches. Alternatively, the top portion 52 of the connection element 50 can include a substantially square opening 57 as shown in FIG. 11, or a substantially circular opening 58 as shown in FIG. 12. Optionally, the connection element 50 further includes a clip, pin, or strap that can be connected to the ladder rack 70 to secure the connection element 50 in place.

As discussed above, the connection element 50 can be formed integrally with or separately from the first axial end 42 of the support leg 40 of each of the first and second rack members 32, 34. Forming the connection element 50 as a separate component that is removably connected to the first axial end 42 of each support leg 40 is advantageous in that the connection element 50 can be easily interchanged to accommodate different roof racks, so that the temporary side cargo rack 30 can be used with different vehicles having roof racks of varying shapes and dimensions or vehicles without roof racks. Furthermore, while the connection elements 50 shown in FIGS. 9, 11, and 12 include openings 56, 57, 58 of various sizes and shapes, the top portion 52 of the connection element 50 can be formed with other configurations to removably engage the existing component of the vehicle. For example and without limitation, the top portion 52 of the connection element 50 can include a flange, hook, or loop adapted to engage the vertical protrusion 72 of the ladder rack 70, or a portion of the horizontal cross members 74 of the ladder rack 70 that is associated with the vehicle 76. A loop at the top portion 52 of the connection element 50 can be made from a rigid material, such as a metal, or can be made from a flexible material, such as nylon or other fabric. The top portion 52 of the connection element 50 can also include an adhesion component, such as a suction cup or magnetic member, which allows the connection element 50 to be attached directly to an outer surface of the vehicle 76. Such an adhesion component would allow the temporary side cargo rack 30 to be used with vehicles that do not have roof racks. Many vehicles include a “gutter,” an indentation formed between the side and top surfaces of the vehicle. Accordingly, the top portion 52 of the connection element 50 can include a component adapted to removably engage the gutter of the vehicle.

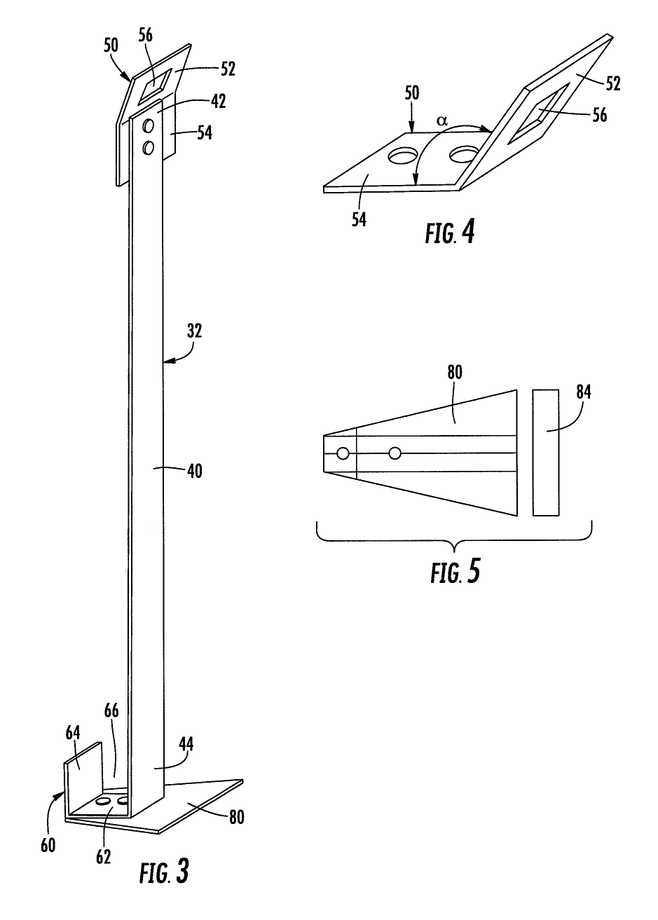

As shown in FIGS. 1-3, 5, and 7, each of the first and second rack members 32, 34 of the temporary side cargo rack 30 can further include a spacer 80 that separates the second axial end 44 of the support leg 40 from a side surface 78 of the vehicle 76. The spacer 80 can be associated with at least one of the support element 60 or the second axial end 44 of the support leg 40, and can be of any suitable size and shape. For example and without limitation, the spacer 80 can be formed as a substantially trapezoidal member having a length of approximately 9 inches, a first base of approximately 2 inches, and a second base of approximately 6 inches. The spacer 80 can be made from any suitable materials having the sufficient structural properties to space the second axial end 44 of the support leg 40 from the side surface 78 of the vehicle 76, even when the temporary side cargo rack 30 is fully loaded, without buckling or causing damage to the vehicle 76. As shown in FIGS. 2 and 5, the spacer 80 can include a bumper 84 that contacts the vehicle 76. The bumper 84 can be made from any suitable material to protect the side surface 78 of the vehicle 76 from being scratched or dented by the spacer 80, such as an elastic or foam material. The bumper 84 can be formed integrally with the spacer 80, or as a separate piece that is attached to the spacer 80 and can be exchanged if necessary. As shown in FIG. 7, due to the spacer 80, the support leg 40 of each of the first and second rack members 32, 34 is arranged at an angle β with respect to the side surface 78 of the vehicle 76. This arrangement allows objects supported by the first and second rack members 32, 34 to tilt towards the vehicle 76 and be more securely transported. The angle β of the first and second rack members 32, 34 can be selected based on the length of each support leg 40 and spacer 80, and can be, for example and without limitation, approximately 10-15°.

The temporary side cargo rack 30 also includes an attachment component 90 associated with each of the first and second rack members 32, 34 to minimize relative movement between the temporary side cargo rack 30 and the vehicle 76. As shown in FIGS. 1 and 2, the attachment component 90 includes a first end 92 removably associated with at least one of the support element 60 or the second axial end 44 of the support leg 40, and a second end 94 configured to be removably associated with the vehicle 76. Preferably, a separate attachment component 90 is provided for each of the first and second rack members 32, 34, so that the first and second rack members 32, 34 can be individually secured to the vehicle 76. The attachment component 90 can be formed as a strap 96, with a separate fastener 98 arranged at each of the first and second ends 92, 94 of the strap 96. The strap 96 can be made from any suitable material having the desired strength and flexibility. For example and without limitation, the strap 96 can be made from a fabric, plastic, polymer, or rubber material, such as nylon. The length of the strap 96 is preferably adjustable so that the temporary side cargo rack 30 can be tightly secured to the vehicle 76, such as through a ratchet system used in tie-down straps. The fasteners 98 arranged at the first and second ends 92, 94 of the strap 96 can be formed as hooks, clasps, clips, buckles, or any other suitable fastener that allows for a removable connection. As shown in FIG. 2, when the fasteners 98 are formed as hooks, the fastener 98 connected to the first end 92 of the strap 96 can selectively engage an opening or indentation 86 formed in the spacer 80, the support element 60, or the second axial end 44 of the support leg 40.

The fastener 98 connected to the second end 94 of the strap 96 can selectively engage a bottom panel edge, rocker panel, frame rail, or other bottom member of the vehicle 76. Once the temporary side cargo rack 30 is secured to the vehicle 76 by the attachment component 90, the first and second rack members 32, 34 are unlikely to move with respect to each other or the vehicle 76, even during travel when the vehicle 76 may hit bumps in the road or quickly accelerate, stop, or make turns. Additional straps or other retention means can be used to secure an object to the temporary side cargo rack 30 so that the object does not shift during travel. The first and second rack members 32, 34 can include openings, protrusions, or other members to aid in securing the transported object.

While the present temporary side cargo rack 30 has been described above in the context of the construction industry, it should be appreciated that the use of the temporary side cargo rack 30 is not limited to building materials and equipment. For example, the temporary side cargo rack 30 can be used to transport artwork such as large canvases and frames, advertisements in the form of large signs or banners, sports equipment, and any other object that can be supported by the first and second rack members 32, 34.

Having thus described various embodiments of the present temporary side cargo rack in detail, it is to be appreciated and will be apparent to those skilled in the art that many physical changes, only a few of which are exemplified in the detailed description above, could be made in the temporary side cargo rack without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A temporary side cargo rack for a vehicle, the temporary side cargo rack comprising a first rack member and a second rack member, each of the first and second rack members comprising:
a support leg having a first axial end and a second axial end;
a connection element associated with the first axial end of the support leg and configured to be removably connected to an existing component of a vehicle;
a support element associated with the second axial end of the support leg, the support element having a base arranged substantially perpendicular to the support leg and a flange that extends from the base; and
an attachment component having a first end removably associated with at least one of the support element or the second axial end of the support leg, and a second end configured to be removably associated with the vehicle.

2. The temporary side cargo rack of claim 1, wherein the first rack member is separate from the second rack member.

3. The temporary side cargo rack of claim 1, wherein the first rack member is removably connected to the second rack member.

4. The temporary side cargo rack of claim 1, wherein each of the first and second rack members further comprises a spacer associated with at least one of the support element or the second axial end of the support leg, the spacer being adapted to space the second axial end of the support leg from a side surface of a vehicle.

5. The temporary side cargo rack of claim 4, wherein the spacer of each of the first and second rack members includes a bumper.

6. The temporary side cargo rack of claim 5, wherein the bumper is formed from an elastic material.

7. The temporary side cargo rack of claim 1, wherein the attachment component of each of the first and second rack members comprises a strap having axial ends and a separate fastener arranged at each of the axial ends.

8. The temporary side cargo rack of claim 7, wherein the strap of the attachment component of each of the first and second rack members has an adjustable length.

9. The temporary side cargo rack of claim 1, wherein the connection element of each of the first and second rack members is removably associated with the first axial end of the support leg.

10. The temporary side cargo rack of claim 1, wherein the connection element of each of the first and second rack members includes a top portion and a bottom portion, the top portion being arranged at an angle with respect to the bottom portion.

11. The temporary side cargo rack of claim 10, wherein the top portion of the connection element of each of the first and second rack members includes an opening adapted to receive the existing component of a vehicle therein.

12. The temporary side cargo rack of claim 10, wherein the top portion of the connection element of each of the first and second rack members includes a fastener adapted to engage the existing component of a vehicle.

13. The temporary side cargo rack of claim 1, wherein the existing component of a vehicle is a portion of a roof rack connected to the vehicle.

14. The temporary side cargo rack of claim 13, wherein the existing component of a vehicle is an outer surface of the vehicle.

15. A removable side cargo rack for a vehicle having an existing roof rack, the removable side cargo rack comprising a first rack member and a second rack member, each of the first and second rack members having a first end removably connected to a portion of the existing roof rack, a second end configured to support an object thereon, and an attachment component configured to connect the second end to a bottom portion of the vehicle.

16. The removable side cargo rack of claim 15, wherein the first rack member is spaced apart from and arranged substantially parallel to the second rack member.

17. The removable side cargo rack of claim 15, wherein the first end of each of the first and second rack members includes a connection element having an opening adapted to receive a protrusion of the existing roof rack therein.

18. The removable side cargo rack of claim 15, wherein the second end of each of the first and second rack members is substantially U-shaped.

19. The removable side cargo rack of claim 15, wherein the second end of each of the first and second rack members is spaced apart from a side surface of a vehicle by a spacer.

20. The removable side cargo rack of claim 15, wherein the attachment component of each of the first and second rack members includes a strap having an adjustable length.
